(19) United States
(12) Patent Application Publication
(10) Pub. No.: US 2025/0175542 A1
(43) Pub. Date: May 29, 2025

(54) COMMUNICATING NON-ACCESS STRATUM INFORMATION IN INTERNET PROTOCOL MESSAGES VIA A WIRELINE CONNECTION

(71) Applicant: Juniper Networks, Inc., Sunnyvale, CA (US)

(72) Inventor: Venkatesh PADEBETTU, Bangalore (IN)

(21) Appl. No.: 18/758,695

(22) Filed: Jun. 28, 2024

(30) Foreign Application Priority Data
Nov. 28, 2023 (IN) 202341080510

(51) Int. Cl. H04L 69/18; H04L 69/168

(52) U.S. Cl. CPC H04L 69/18; H04L 69/168; H04L 2212/00

(57) ABSTRACT

In some implementations, a client device may send to an access gateway function (AGF) device, and via a wireline connection, a first Internet protocol (IP) message that includes non-access stratum (NAS) information. The client device may receive from the AGF device, via the wireline connection, and based on sending the first IP message, a second IP message that includes acknowledgement information. The NAS information may be included in a service data unit (SDU) that is encapsulated in the first IP message. The wireline connection may be a user datagram protocol (UDP) wireline connection or a transmission control protocol (TCP) wireline connection.

### CROSS-REFERENCE TO RELATED APPLICATION

This patent application claims priority to India Patent Application No. 202341080510, filed on Nov. 28, 2023, and entitled “NON-ACCESS STRATUM TRANSPORT FOR CLIENT DEVICES IN CABLE NETWORKS.” The disclosure of the prior application is considered part of and is incorporated by reference into this patent application.

### BACKGROUND

A client device (e.g., a residential gateway, a customer premises equipment (CPE), a user equipment (UE), and/or the like) may be connected to a fifth generation (5G) core network via a wireline connection (e.g., information is transmitted over a physical element, such as a fiber optic able, a coaxial cable, a twisted pair cable, and/or the like).

### SUMMARY

In some implementations, a method includes sending, by a client device, to an access gateway function (AGF) device, and via a wireline connection, a first Internet protocol (IP) message that includes non-access stratum (NAS) information; and receiving, by the client device, from the AGF device, via the wireline connection, and based on sending the first IP message, a second IP message that includes acknowledgement information.

In some implementations, an AGF device includes one or more memories; and one or more processors to: receive, from a client device and via a wireline connection, a first IP message that includes NAS information; and send, to the client device, via the wireline connection, and based on receiving the first IP message, a second IP message that includes acknowledgement information.

In some implementations, a non-transitory computer-readable medium storing a set of instructions includes one or more instructions that, when executed by one or more processors of a client device, cause the client device to: send, to an AGF device and via a wireline connection, an IP message that includes NAS information.

### BRIEF DESCRIPTION OF THE DRAWINGS

FIGS. 1A-1C are diagrams of an example implementation associated with communicating NAS information in IP messages via a wireline connection.

FIG. 2 is a diagram of an example protocol stack associated with systems and/or methods described herein.

FIG. 3 is a diagram of an example control plane stack associated with systems and/or methods described herein.

FIG. 4 is a diagram of an example environment in which systems and/or methods described herein may be implemented.

FIG. 5 is a diagram of example components of a device associated with communicating NAS information in IP messages via a wireline connection.

FIG. 6 is a diagram of example components of a device associated with communicating NAS information in IP messages via a wireline connection.

FIG. 7 is a flowchart of an example process associated with communicating NAS information in IP messages via a wireline connection.

FIG. 8 is a flowchart of an example process associated with communicating NAS information in IP messages via a wireline connection.

### DETAILED DESCRIPTION

The following detailed description of example implementations refers to the accompanying drawings. The same reference numbers in different drawings may identify the same or similar elements.

A client device connected to a 5G core network may need to transmit NAS messages to the 5G core network (e.g., to allow the client device to be serviced by the core network). When the client device is connected to the 5G core via a wireless connection (e.g., when the client device is a 5G residential gateway (5G-RG)), the client device can utilize point-to-point protocol over Ethernet (PPPOE) to transport NAS messages to the core network. However, such an approach cannot be utilized when the client device is connected to the 5G core via a cable network connection (i.e., a type of wireline connection). This is because only IP can be used to transport messages via cable network connections. For example, in a cable network (e.g., a data over cable service interface specification (DOCSIS) cable network), a client device (e.g., a cable modem) is assigned an IP address by a service provider, and therefore IP messages that include the IP address are used for communication of control information between the client device and a cable modem termination system (CMTS) of the cable network. This type of functionality cannot be changed, and thereby prevents adoption of PPPOE-based transport for cable networks.

Consequently, when the client device is connected to a core network via a cable network connection, there is currently no way to transport NAS information between the client device and the core network. Thus, there exists a need for a transport protocol to allow communication of NAS information via a cable network connection.

Some implementations described herein provide a transport protocol between a client device (e.g., a 5G cable residential gateway (5G-CRG)) and an AGF device associated with a core network, where the client device is connected to the AGF device via a wireline connection (e.g., a cable network connection, or another type of wireline connection). The transport protocol may utilize IP and user datagram protocol (UDP) and/or transmission control protocol (TCP) (e.g., to allow communication between the client device and the AGF). For example, the client device may send a first IP message to the AGF device via the wireline connection. The first IP message may include NAS information (e.g., in a service data unit (SDU) of the first IP message). In some implementations, the first IP message further includes an indicator (e.g., that indicates that the first IP message includes the NAS information). For example, the indicator may be a port number that is associated with NAS signaling (e.g., a specific port number of the AGF device that is used by the AGF device to listen for IP messages that include NAS information).

The AGF device may obtain the NAS information from the first IP message and may send a next generation application protocol (NGAP) message to the core network that includes the NAS information. In this way, the AGF facilitates the NAS information being communicated from the client device to the core network. Accordingly, the AGF device may send a second IP message to the client device that includes acknowledgement information, which may indicate that the AGF device received the first IP message, that the AGF device obtained the NAS information from the first IP message, that the AGF device sent the NAS information (e.g., as part of a NGAP message) to the core network, and/or other acknowledgement information.

In this way, some implementations described herein enable the client device to communicate NAS information (e.g., to the core network) via a wireline connection using IP messages. Communicating NAS information via the wireline connection, such as when the wireline connection is a cable network connection, would not otherwise be possible. In this way, some implementations described herein enable a client device associated with a wireline network, such as a cable network, to be serviced by a core network (e.g., a 5G network).

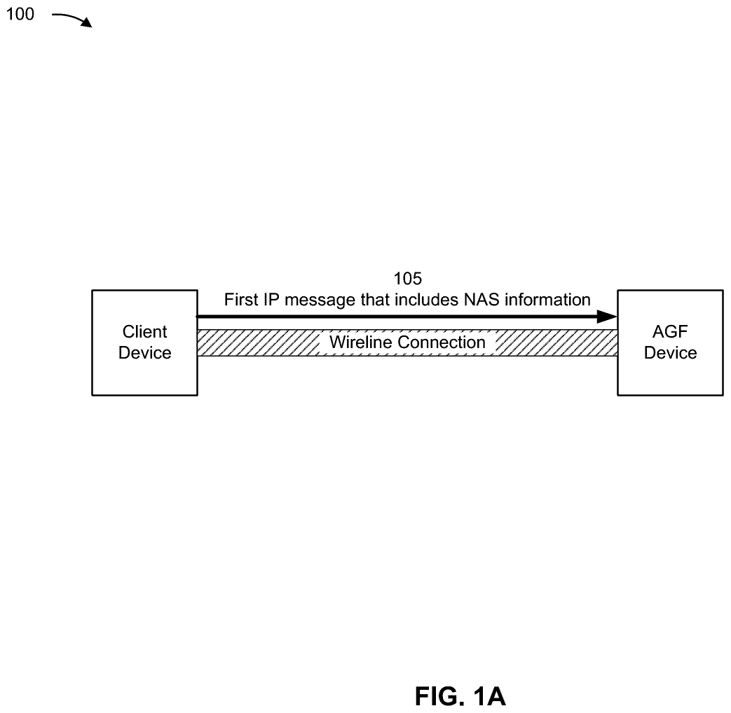

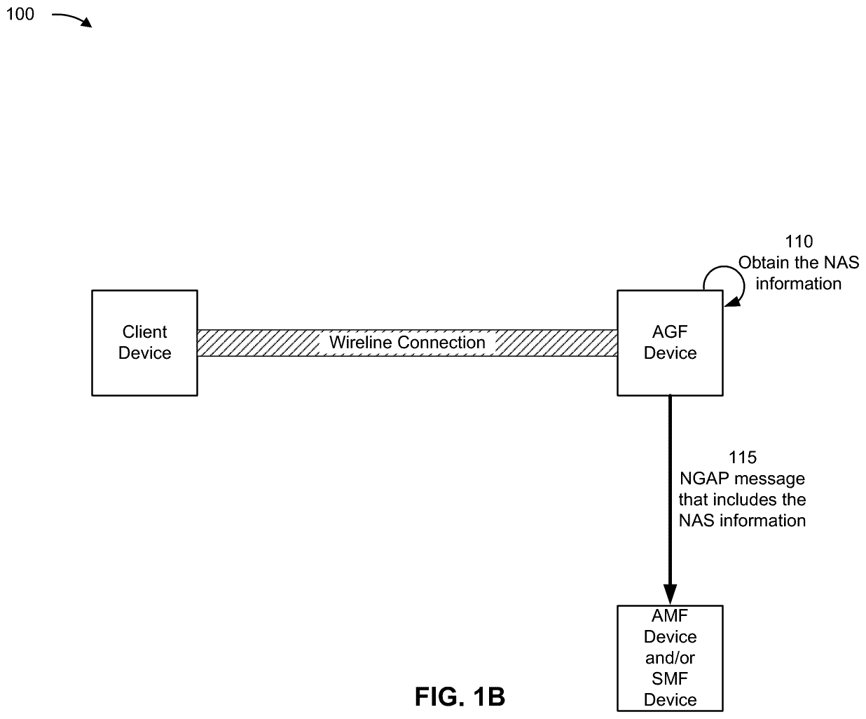

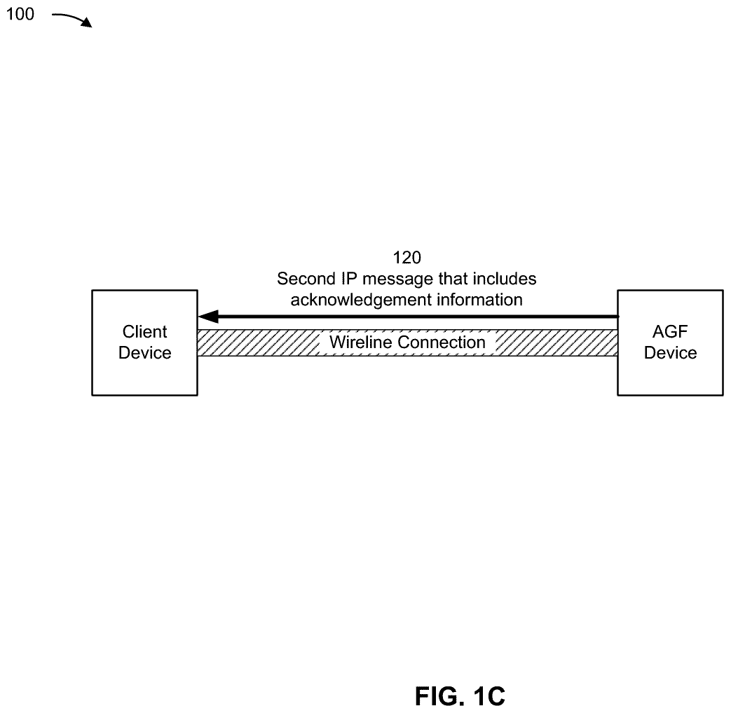

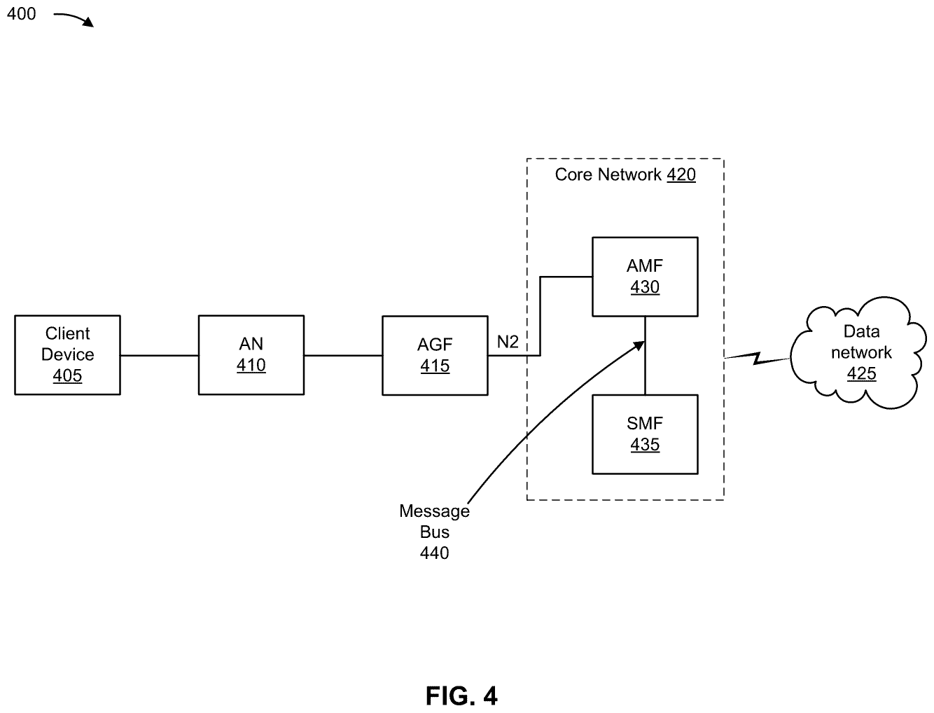

FIGS. 1A-1C are diagrams of an example implementation 100 associated with communicating NAS information in IP messages via a wireline connection. As shown in FIGS. 1A-1C, example implementation 100 includes a client device, an AGF device, an AMF device, and/or an SMF device. These devices are described in more detail below in connection with FIGS. 4-6.

The client device and the AGF device may be associated with a core network. The core network may include an example architecture of a 5G next generation (NG) core network included in a 5G wireless telecommunications system, and may include physical elements, virtual elements, or a combination of physical and virtual elements. The client device may include a network device (e.g., a residential gateway, such as a 5G-RG, a 5G-CRG, or another type of residential gateway), a CPE, a UE, and/or another type of device. The client device may be connected to the AGF via a wireline connection (e.g., the client device and the AGF may be connected via a physical element, such as a fiber optic able, a coaxial cable, a twisted pair cable, and/or the like). The wireline connection may include, for example, a cable network connection, or another type of wireline connection. The AGF may facilitate the client device communicating, via the wireline connection, with one or more functional elements of the core network, such as functional elements associated with the AMF device and/or the SMF device.

The wireline connection may be associated with a transport protocol (e.g., that is associated with the example protocol stack 200 described herein) that is used carry messages between the client device and the AGF (and functional elements of the core network). For example, the wireline connection may be an IP wireline connection, where IP messages are communicated via the wireline connection. In some implementations, the wireline connection may be a particular type of IP wireline connection, such as a UDP wireline connection (e.g., where UDP packets are encapsulated in IP messages) or a TCP connection (e.g., where TCP packets are encapsulated in IP messages).

As shown in FIG. 1A, and by reference number 105, the client device may send a first IP message to the AGF device (e.g., when the wireline connection is an IP wireline connection). For example, the client device may send the first IP message to the AGF device via the wireline connection between the client device and the AGF device, and therefore the AGF device may receive the first IP message from the client device via the wireline connection.

The first IP message may include NAS information. The NAS information may include, for example, authentication information (e.g., that can be used to verify an identity of the client device), session management information (e.g., that can be used to establish, modify, or terminate a packet data unit (PDU) session for the client device), mobility management information (e.g., that can be used to track and service the client device), registration information (e.g., that can be used to register the client device to the core network), capability information (e.g., that can indicate one or more communication capabilities of the client device), and/or other types of NAS information.

In some implementations, the NAS information may be included in an SDU that is included in (e.g., encapsulated in) the first IP message. When the wireline connection is a UDP wireline connection, the NAS information may be included in (e.g., encapsulated in) a UDP packet of the first IP message (e.g., in an SDU that is encapsulated in the UDP packet). Alternatively, when the wireline connection is a TCP wireline connection, the NAS information may be included in (e.g., encapsulated in) a TCP packet of the first IP message (e.g., in an SDU that is encapsulated in the TCP packet).

In some implementations, the first IP message further includes an indicator. The indicator may indicate that the first IP message includes the NAS information. For example, the indicator may be a port number that is associated with NAS signaling (e.g., a specific port number of the AGF device that is used by the AGF device to listen for IP messages that include NAS information).

As shown in FIG. 1B, and by reference number 110, the AGF device may obtain the NAS information (e.g., based on receiving the first IP message). In some implementations, to obtain the NAS information, the AGF device may process (e.g., read and/or parse) the first IP message to identify NAS information included in the first IP message and to extract the NAS information from the first IP message. The AGF device may perform one or more decapsulation operations on the first IP message to obtain the NAS information. For example, the AGF may perform one or more operations to decapsulate a UDP packet or TCP packet from the first IP message, to decapsulate an SDU from the UDP packet or the TCP packet, and/or to decapsulate the NAS information from the SDU.

As shown in FIG. 1B, and by reference number 115, the AGF device may send a next generation application protocol (NGAP) message to at least one of the AMF device or the SMF device. For example, the AGF device may send the NGAP message to at least one of the AMF device or the SMF device via an interface of the core network, such as an N2 interface (that is defined by the Third Generation Partnership Project (3GPP)) of the core network. Therefore, at least one of the AMF device or the SMF device may receive the NGAP message from the AGF device via the interface of the core network. The NGAP message may include the NAS information. In this way, the AGF facilitates the NAS information being communicated from the client device to the core network (e.g., at least one of the AMF device or the SMF device).

As shown in FIG. 1C, and by reference number 120, the AGF device may send a second IP message to the client device (e.g., when the wireline connection is an IP wireline connection). For example, the AGF device may send the second IP message to the client device via the wireline connection between the client device and the AGF device, and therefore the client device may receive the second IP message from the AGF device via the wireline connection.

The second IP message may include acknowledgement information. The acknowledgement information may indicate that the AGF device received the first IP message, that the AGF device obtained the NAS information from the first IP message, that the AGF device sent the NAS information (e.g., as part of a NGAP message) to the core network (e.g., to at least one of the AMF device or the SMF device), and/or other acknowledgement information.

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

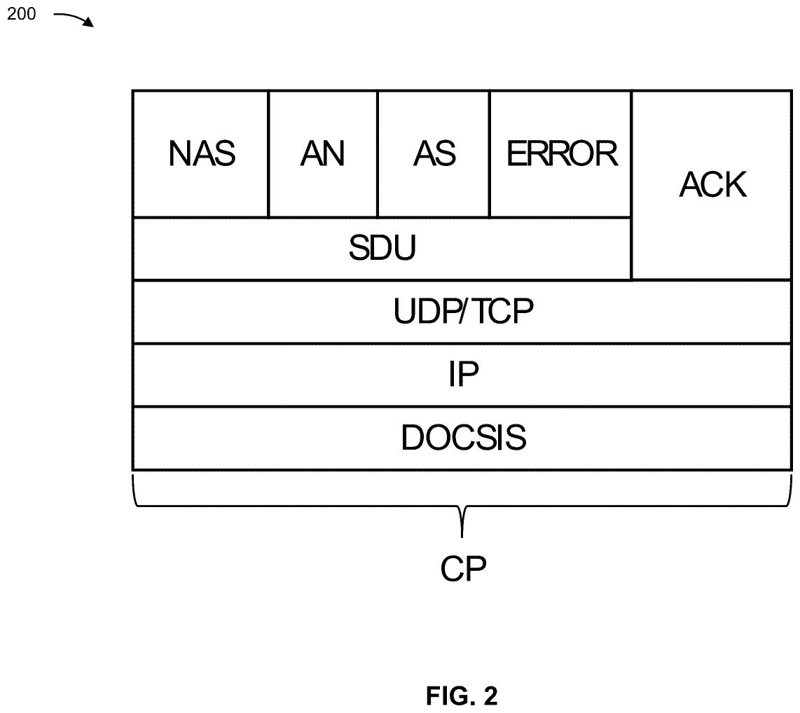

FIG. 2 is a diagram of an example protocol stack 200 associated with systems and/or methods described herein. The example protocol stack 200 may be referred to as a 5G-CRG protocol stack. As shown in FIG. 2, the example protocol stack 200 is associated with a control plane (CP) of a core network (e.g., core network 420 described herein). As further shown in FIG. 2, the example protocol stack 200 may include a wireline connection portion (e.g., that is associated with a cable network protocol, such as a data over cable service interface specification (DOCSIS) protocol, or another wireline connection protocol), an IP portion (e.g., that is encapsulated in the wireline connection portion), and one of a UDP portion or a TCP portion (e.g., that is encapsulated in the IP portion). An SDU that is configured to include NAS information (e.g., as described elsewhere herein) may be included (e.g., encapsulated) in the UDP portion or the TCP portion of the example protocol stack 200. The SDU may be further configured to include access network (AN) parameters (e.g., of an access network of a client device), access stratum (AS) parameters (e.g., for communicating with the client device), and/or error parameters (e.g., that are used to handle errors associated with communicating with the client device). In some implementations, the UDP portion or the TCP portion may include an acknowledgement (ACK) parameter (e.g., to confirm receipt of a message by the client device).

As indicated above, FIG. 2 is provided as an example. Other examples may differ from what is described with regard to FIG. 2.

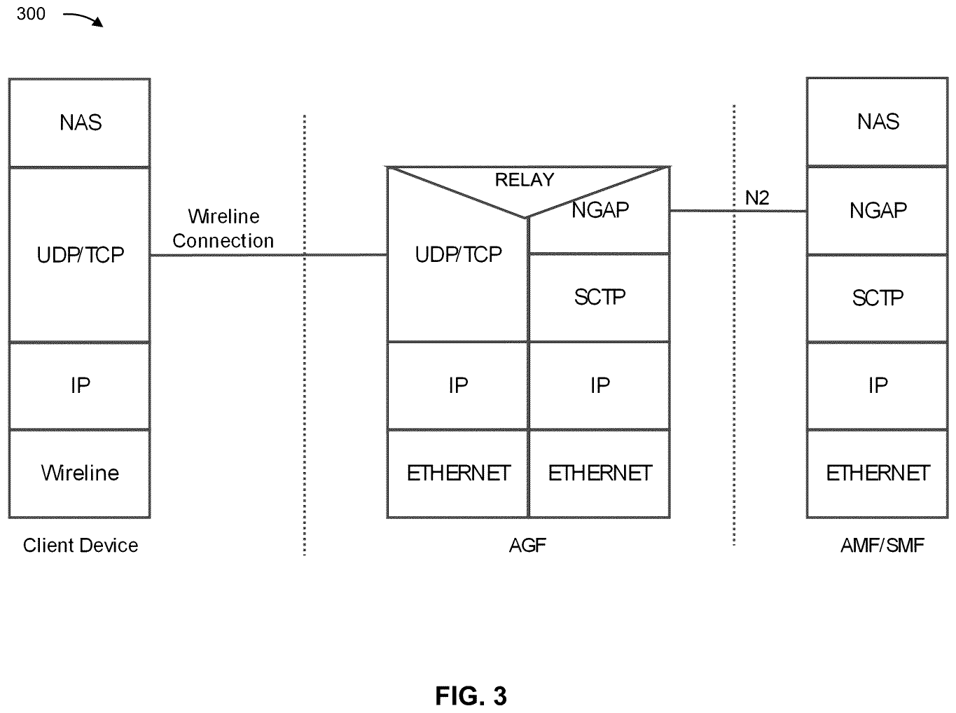

FIG. 3 is a diagram of an example control plane stack 300 associated with systems and/or methods described herein. The example control plane stack 300 is associated with a core network (e.g., core network 420 described herein). As further shown in FIG. 3, the example control plane stack 300, for a client device that is to communicate with the core network, may include a wireline connection portion, an IP portion, one of a UDP portion or a TCP portion, and an NAS portion (e.g., that is encapsulated in the UDP portion or the TCP portion). Further, the example control plane stack 300, for an AGF that facilitates communication between the client device and the core network, may include a first Ethernet portion, a first IP portion, and one of a UDP portion or a TCP portion, to facilitate communication with the client device via a wireline connection between the client device and the AGF.

Additionally, as further shown in FIG. 3, the example control plane stack 300, for the AGF, may further include a second Ethernet portion, a second IP portion, a stream control transmission protocol (SCTP) portion, and an NGAP portion. Further, the example control plane stack 300, for an AMF or an SMF of the core network, may include an Ethernet portion, an IP portion, an SCTP portion, an NGAP portion, and an NAS portion to facilitate communication with the AGF via an interface (e.g., an N2 interface) between the AGF and the core network (e.g., the AMF or the SMF).

As indicated above, FIG. 3 is provided as an example. Other examples may differ from what is described with regard to FIG. 3.

FIG. 4 is a diagram of an example environment 400 in which systems and/or methods described herein may be implemented. As shown in FIG. 4, example environment 400 may include client device 405, AN 410, AGF 415, a core network 420, and a data network 425. Devices and/or networks of example environment 400 may interconnect via wired connections, wireless connections, or a combination of wired and wireless connections.

Client device 405 includes one or more devices capable of receiving, generating, storing, processing, and/or providing information, such as information described herein. Client device 405 may be, may be similar to, or may include, the client device described herein in relation to FIGS. 1A-1C. Client device 405 may include a residential gateway (e.g., a 5G-CRG, a 5G-RG, or another type of residential gateway), a CPE, a UE, a network device (e.g., a label switching router (LSR), a label edge router (LER), an ingress router, an egress router, a provider router, a virtual router, a gateway, a switch, a firewall, a hub, a bridge, a reverse proxy, a proxy server, a cloud server, a data center server, a load balancer, and/or the like), or a similar type of device. In some implementations, client device 405 may receive network traffic from and/or may provide network traffic to core network 420, such as via AN 410 and AGF 415. In some implementations, client device 405 may be connected to AGF 415 via a wireline connection (which may or may not also connect AN 410).

AN 410 may include one or more nodes that are associated with a wireline connection to core network 420. AN 410 may include a central unit (CU) that includes a next generation (NG) interface connecting the CU to a core unit (e.g., a next gen core (NGC) unit), which may be a node of core network 420. AN 410 may transfer traffic between client device 405 and core network 420. In some implementations, AN 410 may perform scheduling and/or resource management for client device 405 covered by AN 410. In some implementations, AN 410 may be controlled or coordinated by a network controller, which may perform load balancing, network-level configuration, and/or the like. A network controller may communicate with AN 410 via a wireless or wireline backhaul. In some implementations, AN 410 may include a network controller, a self-organizing network (SON) module or component, or a similar module or component. In other words, AN 410 may perform network control, scheduling, and/or network management functions (e.g., for uplink, downlink, and/or sidelink communications of client device 405 covered by AN 410).

AGF 415 may include one or more devices, between a wireline access infrastructure (e.g., AN 410) and core network 420, that support residential gateways (e.g., client device 405) that support 5G NAS signaling and residential gateways that are purely wireline. AGF 415 connects to one or more functional elements of the core network 420 (e.g., AMF 430 and/or SMF 435) via an N2 interface.

In some implementations, core network 420 may include an example functional architecture in which systems and/or methods described herein may be implemented. For example, core network 420 may include an example architecture of a 5G NG core network included in a 5G wireless telecommunications system. While the example architecture of core network 420 shown in FIG. 4 may be an example of a service-based architecture, in some implementations, core network 420 may be implemented as a reference-point architecture.

As shown in FIG. 4, core network 420 may include a number of functional elements. The functional elements may include, for example, an access and mobility management function (AMF) 430 and session management function (SMF) 435, as well as other functional elements. These functional elements may be communicatively connected via a message bus 440. Each of the functional elements shown in FIG. 4 is implemented on one or more devices associated with a wireless telecommunications system. In some implementations, one or more of the functional elements may be implemented on physical devices, such as an access point, a base station, a gateway, and/or the like. In some implementations, one or more of the functional elements may be implemented on a computing device of a cloud computing environment.

AMF 430 includes one or more devices that act as a termination point for NAS signaling, mobility management, and/or the like. SMF 435 includes one or more devices that support the establishment, modification, and release of communications sessions in the wireless telecommunications system.

Message bus 440 represents a communication structure for communication among the functional elements. In other words, message bus 440 may permit communication between two or more functional elements. The message bus 440 may be a logical and/or physical communication structure for communication among the functional elements. Accordingly, the message bus 440 may permit communication between two or more functional elements, whether logically (e.g., using one or more application programming interfaces (APIs), among other examples) and/or physically (e.g., using one or more wired and/or wireless connections).

Data network 425 includes one or more wired and/or wireless data networks. For example, data network 425 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example environment 400 may perform one or more functions described as being performed by another set of devices of example environment 400.

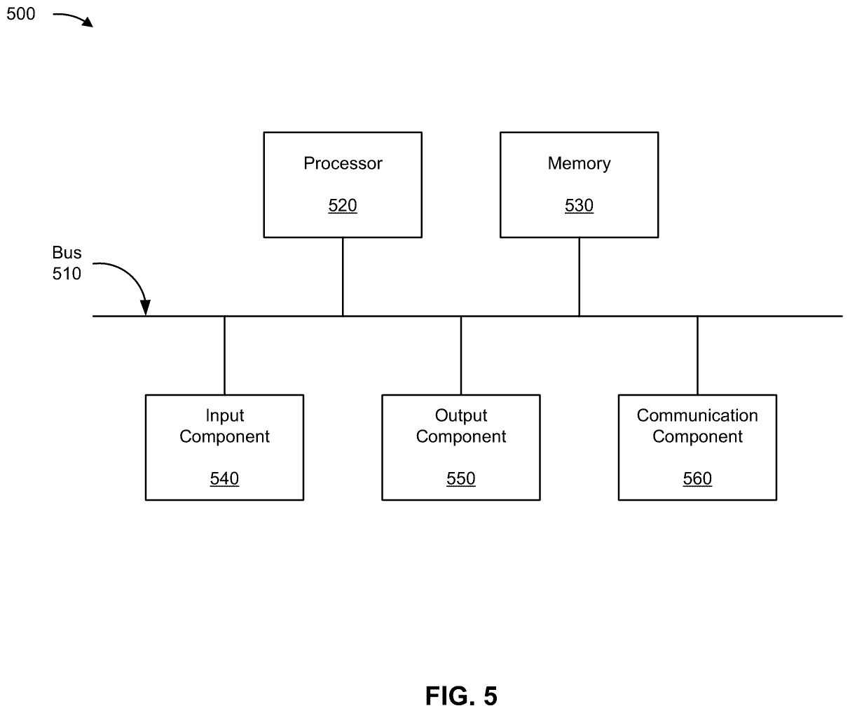

FIG. 5 is a diagram of example components of a device 500 associated with communicating NAS information in IP messages via a wireline connection. The device 500 may correspond to client device 405, AN 410, AGF 415, AMF 430, and/or SMF 435. In some implementations, client device 405, AN 410, AGF 415, AMF 430, and/or SMF 435 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection).

The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

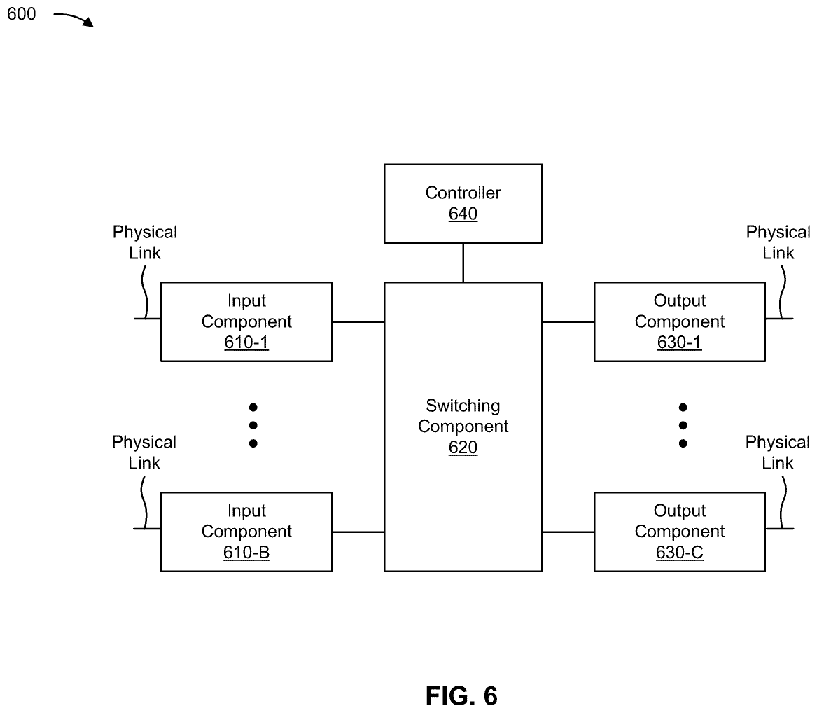

FIG. 6 is a diagram of example components of a device 600 associated with communicating NAS information in IP messages via a wireline connection. Device 600 may correspond to client device 405, AN 410, AGF 415, AMF 430, and/or SMF 435. In some implementations, client device 405, AN 410, AGF 415, AMF 430, and/or SMF 435 may include one or more devices 600 and/or one or more components of device 600. As shown in FIG. 6, device 600 may include one or more input components 610-1 through 610-B (B≥1) (hereinafter referred to collectively as input components 610, and individually as input component 610), a switching component 620, one or more output components 630-1 through 630-C (C≥1) (hereinafter referred to collectively as output components 630, and individually as output component 630), and a controller 640.

Input component 610 may be one or more points of attachment for physical links and may be one or more points of entry for incoming traffic, such as packets. Input component 610 may process incoming traffic, such as by performing data link layer encapsulation or decapsulation. In some implementations, input component 610 may transmit and/or receive packets. In some implementations, input component 610 may include an input line card that includes one or more packet processing components (e.g., in the form of integrated circuits), such as one or more interface cards (IFCs), packet forwarding components, line card controller components, input ports, processors, memories, and/or input queues. In some implementations, device 600 may include one or more input components 610.

Switching component 620 may interconnect input components 610 with output components 630. In some implementations, switching component 620 may be implemented via one or more crossbars, via busses, and/or with shared memories. The shared memories may act as temporary buffers to store packets from input components 610 before the packets are eventually scheduled for delivery to output components 630. In some implementations, switching component 620 may enable input components 610, output components 630, and/or controller 640 to communicate with one another.

Output component 630 may store packets and may schedule packets for transmission on output physical links. Output component 630 may support data link layer encapsulation or decapsulation, and/or a variety of higher-level protocols. In some implementations, output component 630 may transmit packets and/or receive packets. In some implementations, output component 630 may include an output line card that includes one or more packet processing components (e.g., in the form of integrated circuits), such as one or more IFCs, packet forwarding components, line card controller components, output ports, processors, memories, and/or output queues. In some implementations, device 600 may include one or more output components 630. In some implementations, input component 610 and output component 630 may be implemented by the same set of components (e.g., and input/output component may be a combination of input component 610 and output component 630).

Controller 640 includes a processor in the form of, for example, central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor is implemented in hardware, firmware, or a combination of hardware and software. In some implementations, controller 640 may include one or more processors that can be programmed to perform a function.

In some implementations, controller 640 may include a RAM, a ROM, and/or another type of dynamic or static storage device (e.g., a flash memory, a magnetic memory, an optical memory, etc.) that stores information and/or instructions for use by controller 640.

In some implementations, controller 640 may communicate with other devices, networks, and/or systems connected to device 600 to exchange information regarding network topology. Controller 640 may create routing tables based on the network topology information, may create forwarding tables based on the routing tables, and may forward the forwarding tables to input components 610 and/or output components 630. Input components 610 and/or output components 630 may use the forwarding tables to perform route lookups for incoming and/or outgoing packets.

Controller 640 may perform one or more processes described herein. Controller 640 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with controller 640 from another computer-readable medium or from another device via a communication interface. When executed, software instructions stored in a memory and/or storage component associated with controller 640 may cause controller 640 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

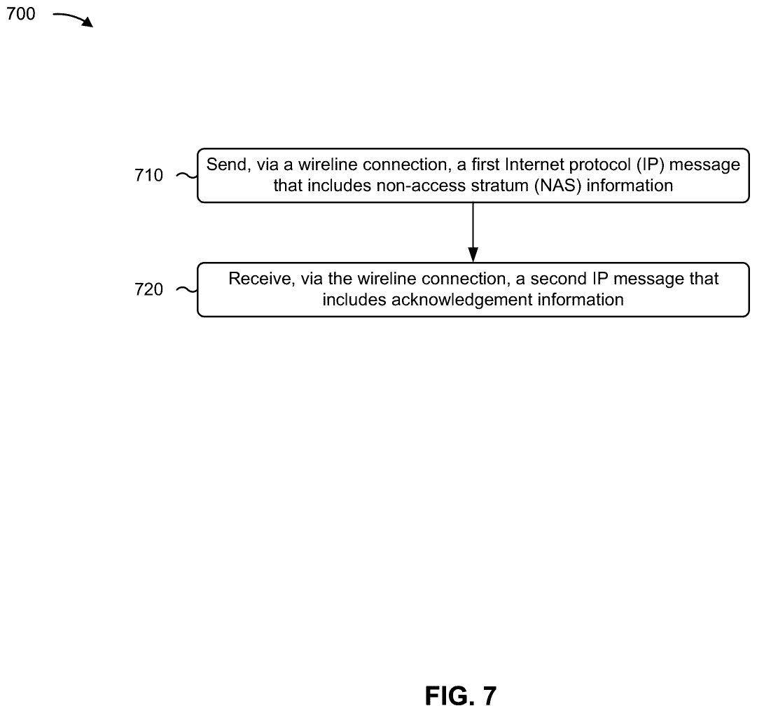

FIG. 7 is a flowchart of an example process 700 associated with communicating NAS information in IP messages via a wireline connection. In some implementations, one or more process blocks of FIG. 7 are performed by a client device (e.g., client device 405). In some implementations, one or more process blocks of FIG. 7 are performed by another device or a group of devices separate from or including the client device, such as an AGF device (e.g., AGF 415), an AMF device (e.g., AMF 430), and/or an SMF device (e.g., SMF 435). Additionally, or alternatively, one or more process blocks of FIG. 7 may be performed by one or more components of device 500, such as processor 520, memory 530, input component 540, output component 550, and/or communication component 560. Additionally, or alternatively, one or more process blocks of FIG. 7 may be performed by one or more components of device 600, such as input component 610, switching component 620, output component 630, and/or controller 640.

As shown in FIG. 7, process 700 may include sending, via a wireline connection, a first IP message that includes NAS information (block 710). For example, the client device may send, to an AGF device, and via a wireline connection, a first IP message that includes NAS information, as described above.

As further shown in FIG. 7, process 700 may include receiving, via the wireline connection, a second IP message that includes acknowledgement information (block 720). For example, the client device may receive, from the AGF device, via the wireline connection, and based on sending the first IP message, a second IP message that includes acknowledgement information, as described above.

Process 700 may include additional implementations, such as any single implementation or any combination of implementations described below and/or in connection with one or more other processes described elsewhere herein.

In a first implementation, the NAS information is included in an SDU that is encapsulated in the first IP message.

In a second implementation, alone or in combination with the first implementation, the wireline connection is a UDP wireline connection.

In a third implementation, alone or in combination with one or more of the first and second implementations, the wireline connection is a TCP wireline connection.

In a fourth implementation, alone or in combination with one or more of the first through third implementations, the first IP message further includes an indicator that the first IP message includes the NAS information.

In a fifth implementation, alone or in combination with one or more of the first through fourth implementations, the indicator is a port number that is associated with NAS signaling.

In a sixth implementation, alone or in combination with one or more of the first through fifth implementations, sending the first IP message to the AGF device allows the AGF device to obtain the NAS information from the first IP message and to send the NAS information in an NGAP message to at least one of an AMF device or an SMF device.

In a seventh implementation, alone or in combination with one or more of the first through sixth implementations, the client device is a 5G-CRG.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

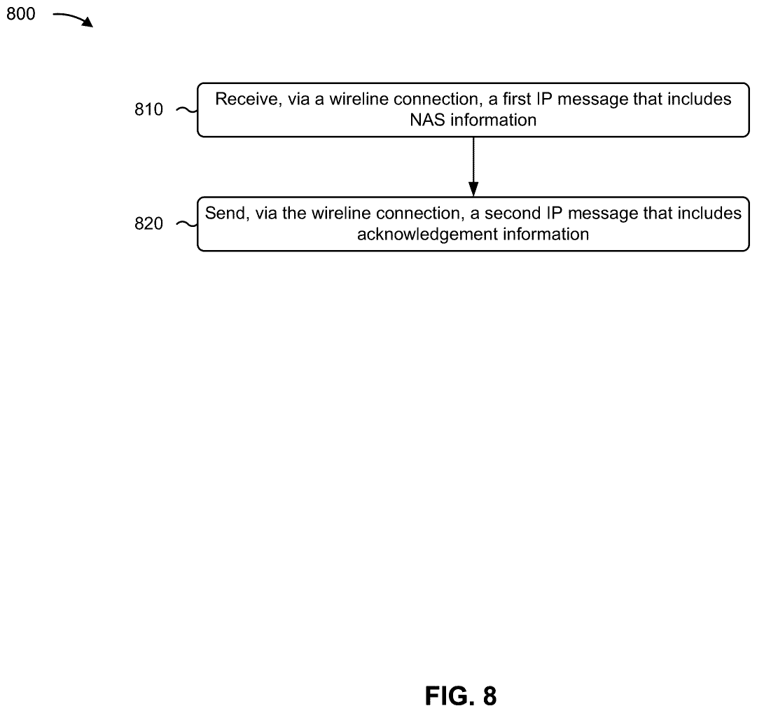

FIG. 8 is a flowchart of an example process 800 associated with communicating NAS information in IP messages via a wireline connection. In some implementations, one or more process blocks of FIG. 8 are performed by an AGF device (e.g., AGF 415). In some implementations, one or more process blocks of FIG. 8 are performed by another device or a group of devices separate from or including the AGF device, such as a client device (e.g., client device 405), an AMF device (e.g., AMF 430), and/or an SMF device (e.g., SMF 435). Additionally, or alternatively, one or more process blocks of FIG. 8 may be performed one or more components of device 500, such as processor 520, memory 530, input component 540, output component 550, and/or communication component 560. Additionally, or alternatively, one or more process blocks of FIG. 8 may be performed by one or more components of device 600, such as input component 610, switching component 620, output component 630, and/or controller 640.

As shown in FIG. 8, process 800 may include receiving, via a wireline connection, a first IP message that includes NAS information (block 810). For example, the AGF device may receive, from a client device and via a wireline connection, a first IP message that includes NAS information, as described above.

As further shown in FIG. 8, process 800 may include sending, via the wireline connection, a second IP message that includes acknowledgement information (block 820). For example, the AGF device may send, to the client device, via the wireline connection, and based on receiving the first IP message, a second IP message that includes acknowledgement information, as described above.

Process 800 may include additional implementations, such as any single implementation or any combination of implementations described below and/or in connection with one or more other processes described elsewhere herein.

In a first implementation, process 800 includes obtaining the NAS information from the first IP message, and sending an NGAP message that includes the NAS information to at least one of an AMF device or an SMF device.

In a second implementation, alone or in combination with the first implementation, the NAS information is included in an SDU that is encapsulated in the first IP message.

In a third implementation, alone or in combination with one or more of the first and second implementations, the wireline connection is a UDP wireline connection.

In a fourth implementation, alone or in combination with one or more of the first through third implementations, the wireline connection is a TCP wireline connection.

In a fifth implementation, alone or in combination with one or more of the first through fourth implementations, the first IP message further includes an indicator that the first IP message includes the NAS information.

In a sixth implementation, alone or in combination with one or more of the first through fifth implementations, the indicator is a port number that is associated with NAS signaling.

Although FIG. 8 shows example blocks of process 800, in some implementations, process 800 includes additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, traffic or content may include a set of packets. A packet may refer to a communication structure for communicating information, such as a protocol data unit (PDU), a service data unit (SDU), a network packet, a datagram, a segment, a message, a block, a frame (e.g., an Ethernet frame), a portion of any of the above, and/or another type of formatted or unformatted unit of data capable of being transmitted via a network.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors to: perform X; perform Y; and perform Z,” that claim should be interpreted to mean “one or more processors to perform X; one or more (possibly different) processors to perform Y; and one or more (also possibly different) processors to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
sending, by a client device, to an access gateway function (AGF) device, and via a wireline connection, a first Internet protocol (IP) message that includes non-access stratum (NAS) information; and
receiving, by the client device, from the AGF device, via the wireline connection, and based on sending the first IP message, a second IP message that includes acknowledgement information.

2. The method of claim 1, wherein the NAS information is included in a service data unit (SDU) that is encapsulated in the first IP message.

3. The method of claim 1, wherein the wireline connection is a user datagram protocol (UDP) wireline connection.

4. The method of claim 1, wherein the wireline connection is a transmission control protocol (TCP) wireline connection.

5. The method of claim 1, wherein the first IP message further includes an indicator that the first IP message includes the NAS information.

6. The method of claim 5, wherein the indicator is a port number that is associated with NAS signaling.

7. The method of claim 1, wherein sending the first IP message to the AGF device allows the AGF device to obtain the NAS information from the first IP message and to send the NAS information in a next generation application protocol (NGAP) message to at least one of an access and mobility management function (AMF) device or a session management function (SMF) device.

8. The method of claim 1, wherein the client device is a fifth generation (5G) cable residential gateway (5G-CRG).

9. An access gateway function (AGF) device, comprising:
one or more memories; and
one or more processors to:
receive, from a client device and via a wireline connection, a first Internet protocol (IP) message that includes non-access stratum (NAS) information; and
send, to the client device, via the wireline connection, and based on receiving the first IP message, a second IP message that includes acknowledgement information.

10. The AGF device of claim 9, wherein the one or more processors are further to:
obtain the NAS information from the first IP message; and
send a next generation application protocol (NGAP) message that includes the NAS information to at least one of an access and mobility management function (AMF) device or a session management function (SMF) device.

11. The AGF device of claim 9, wherein the NAS information is included in a service data unit (SDU) that is encapsulated in the first IP message.

12. The AGF device of claim 9, wherein the wireline connection is a user datagram protocol (UDP) wireline connection.

13. The AGF device of claim 9, wherein the wireline connection is a transmission control protocol (TCP) wireline connection.

14. The AGF device of claim 9, wherein the first IP message further includes an indicator that the first IP message includes the NAS information.

15. The AGF device of claim 14, wherein the indicator is a port number that is associated with NAS signaling.

16. A non-transitory computer-readable medium storing a set of instructions, the set of instructions comprising:
one or more instructions that, when executed by one or more processors of a client device, cause the client device to:
send, to an access gateway function (AGF) device and via a wireline connection, an Internet protocol (IP) message that includes non-access stratum (NAS) information.

17. The non-transitory computer-readable medium of claim 16, wherein the NAS information is included in a service data unit (SDU) of the IP message.

18. The non-transitory computer-readable medium of claim 16, wherein the NAS information is included in a user datagram protocol (UDP) packet of the IP message.

19. The non-transitory computer-readable medium of claim 16, wherein the NAS information is included in a transmission control protocol (TCP) packet of the IP message.

20. The non-transitory computer-readable medium of claim 16, wherein the IP message further includes an indicator that the IP message includes the NAS information.
